(19) United States
(12) Patent Application Publication
(10) Pub. No.: US 2025/0258652 A1
(43) Pub. Date: Aug. 14, 2025

(54) INFORMATION PROCESSING APPARATUS, CONTROL METHOD OF AN INFORMATION PROCESSING APPARATUS, AND NON-TRANSITORY COMPUTER-READABLE STORAGE MEDIUM

(71) Applicant: NEC Corporation, Tokyo (JP)

(72) Inventors: Masaki INOKUCHI, Tokyo (JP); Masaharu MORIMOTO, Tokyo (JP)

(73) Assignee: NEC Corporation, Tokyo (JP)

(21) Appl. No.: 19/027,026

(22) Filed: Jan. 17, 2025

(30) Foreign Application Priority Data
Feb. 9, 2024 (JP) 2024-018338

(51) Int. Cl. G06F 8/10; G06F 8/20

(52) U.S. Cl. CPC G06F 8/10; G06F 8/20

(57) ABSTRACT

An information processing apparatus includes a structuring control means and a concretization control means. The structuring control means acquires request information described in a natural language, generates at least one or more requirement information candidates based on the acquired request information, and structures the generated at least one or more requirement information candidates. The concretization control means concretizes the at least one or more structured requirement information candidates.

### INCORPORATION BY REFERENCE

This application is based upon and claims the benefit of priority from Japanese Patent Application No. 2024-18338, filed on Feb. 9, 2024, the disclosure of which is incorporated herein in its entirety by reference.

### TECHNICAL FIELD

The present invention relates to an information processing apparatus, a control method of an information processing apparatus, and a non-transitory computer-readable storage medium storing a program.

### BACKGROUND ART

There are technologies that assist in systems and software design.

For example, Patent Literature 1 (JP2017-033562 A)

discloses a method for model-based design of safety-critical software. The system disclosed in Patent Literature 1 receives natural language software requirement, develops a specification model by implementing either semantic modeling or graphical modeling, and applies formal requirement analysis to the specification model.

The system further automatically generates requirement-based and robustness test case from the specification model, develops a design model based on the specification model, applies the test case to the design model, and automatically generates source code using the design model.

The system further verifies the source code using both the test case and static analysis technique, and compiles executable object code from the verified source code. Further, if the results of the software specification or analysis of the design model are not satisfactory, the system then adjusts the specification or design model to modify any inconsistencies, and then applies the analysis and test case iteratively.

Requirements definition is important in system development (system design) related to large-scale networks, and so on. Requirements definition is especially important in the development of systems that are composed by combining a plurality of components based on various requirements for the systems, and so on.

Requirements definitions are generated from a system request. For example, if an inexperienced engineer or the like generates a requirement definition, there are cases in which the requirement definition that includes contradictions or is lacking in information is generated.

### SUMMARY

It is a main object of the present invention to provide an information processing apparatus, a control method of an information processing apparatus, and a program, which contribute to enabling a user to generate a more accurate requirement definition.

According to a first aspect of the present invention, there is provided an information processing apparatus, including: a structuring control means that acquires request information described in a natural language, generates at least one or more requirement information candidates based on the acquired request information, and structures the generated at least one or more requirement information candidates; and a concretization control means that concretizes the at least one or more structured requirement information candidates.

According to a second aspect of the present invention, there is provided a control method of an information processing apparatus, the control method including: a structuring control step that acquires request information described in a natural language, generates at least one or more requirement information candidates based on the acquired request information, and structures the generated at least one or more requirement information candidates; and a concretization control step that concretizes the at least one or more structured requirement information candidates.

According to a third aspect of the present invention, there is provided a non-transitory computer-readable storage medium storing a program causing a computer mounted on an information processing apparatus to perform processing for: a structuring control processing that acquires request information described in a natural language, generates at least one or more requirement information candidates based on the acquired request information, and structures the generated at least one or more requirement information candidates; and a concretization control processing that concretizes the at least one or more structured requirement information candidates.

### BRIEF DESCRIPTION OF THE DRAWINGS

Exemplary features and advantages of the present invention

will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an example embodiment of the present disclosure;

FIG. 4 is a diagram illustrating an example of a processing configuration of an assistance apparatus according to the example embodiment of the present disclosure;

FIG. 5 is a diagram illustrating an example of a display of a terminal according to the example embodiment of the present disclosure;

FIG. 6 is a flowchart illustrating an example of an example of an operation of the assistance apparatus according to the example embodiment of the present disclosure;

FIG. 7 is a diagram illustrating the operation of the assistance apparatus according to the example embodiment of the present disclosure;

FIG. 8 is a diagram illustrating an example of a display of the terminal according to a variation of the example embodiment of the present disclosure;

FIG. 9 is a diagram illustrating an example of a processing configuration of the assistance apparatus according to the example embodiment of the present disclosure; and

FIG. 10 is a diagram illustrating an example of a hardware configuration of the assistance apparatus of the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

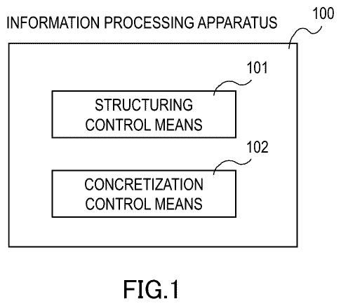

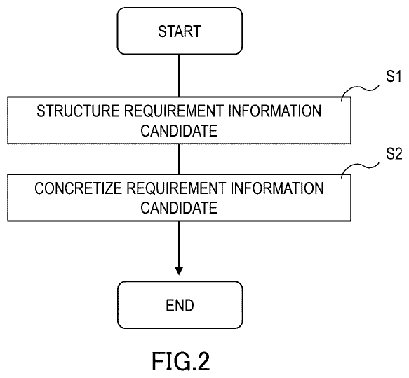

An information processing apparatus 100 according to an example embodiment includes a structuring control means 101 and a concretization control means 102 (see FIG. 1). The structuring control means 101 acquires request information described in a natural language, generates at least one or more requirement information candidates based on the acquired request information, and structures the generated at least one or more requirement information candidates (step S1 in FIG. 2). The concretization control means 102 concretizes the at least one or more structured requirement information candidates (step S2).

Once the information processing apparatus 100 acquires a system request from a user, the information processing apparatus 100 generates at least one or more candidates of requirement information corresponding to the system request. More specifically, the information processing apparatus 100 interprets an element acquired from the system request from various perspectives, and generates a plurality of requirement information candidates by combining the acquired new elements. The information processing apparatus 100 converts each of the plurality of requirement information candidates into a machine-processable format and generates structured requirement information candidates. The information processing apparatus 100 attempts to concretize each of the plurality of structured requirement information candidates. The information processing apparatus 100 can provide information related to the requirement information candidate that has been successfully concretized (the requirement information candidate for which a concrete draft design has been acquired) to the user. The user is provided with the candidate of requirement information that is determined to be feasible. The user can generate more accurate requirement information (requirement definition) by verifying the provided candidate of requirement information.

Hereinafter, specific example embodiments will be described in more detail with reference to drawings.

### First Example Embodiment

A first example embodiment will be described in more detail with reference to drawings.

### Configuration and Outline of Operation of System

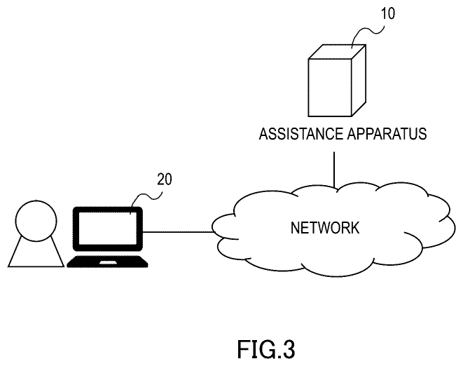

As shown in FIG. 3, an information processing system according to the first example embodiment includes an assistance apparatus 10 and a terminal 20.

The assistance apparatus 10 is the information processing apparatus that assists a system design by a user. For example, the assistance apparatus 10 is a server apparatus installed on a network (on a cloud).

The user operates the terminal 20 to access the assistance apparatus 10. The user inputs various information into the assistance apparatus 10 or acquires various information from the assistance apparatus 10.

The assistance apparatus 10 acquires a system request (a function or purpose required for a system), which is referred to as a business request definition or a systemization request definition. For example, the assistance apparatus 10 acquires the system request (request information) described in a natural language from the user.

For example, the assistance apparatus 10 acquires a system request from a person in charge of a vendor company responsible for system development. The person in charge of the vendor company inputs a request, or the like, for a system from a client company to the assistance apparatus 10 as the system request.

The assistance apparatus 10 generates at least one or more candidates of system requirement (information in which a function or non-function required for a system is organized) based on the acquired system request (request information that includes a natural language). The assistance apparatus 10 generates the candidate of system requirement (requirement information), which consists of a component of the system and a performance indicator associated with the component.

The assistance apparatus 10 structures at least one or more generated candidates of requirement information (hereinafter referred to as requirement information candidates). The assistance apparatus 10 structures the requirement information candidate by converting each requirement information candidate into a predetermined format that can be processed by a machine.

The assistance apparatus 10 generates design information that concretizes the component and/or the performance indicator with respect to each structured requirement information candidate. The assistance apparatus 10 determines feasibility of each requirement information candidate in the process of generating the design information for each requirement information candidate.

The assistance apparatus 10 provides the user with the design information (draft system configuration) corresponding to the requirement information candidate that is determined to be feasible among at least one or more of the structured requirement information candidates.

For example, the assistance apparatus 10 acquires a system request such as “a video distribution system that enables 10,000 people to watch simultaneously” from the user. The assistance apparatus 10 generates a plurality of requirement information candidates from the system request.

For example, in the above example, the assistance apparatus 10 generates the requirement information candidate (candidate for requirement definition) such as “network line; fixed line, communication quality; 100 Mbps” or “network line; mobile line, communication quality; 10 Mbps.”

The assistance apparatus 10 structures each generated requirement information candidate. Note that structuring the requirement information candidate includes converting the requirement information candidate into a predetermined format or expressing the requirement information candidate in a predetermined vocabulary. For example, the assistance apparatus 10 converts each requirement information candidate into a predetermined format such as JSON (JavaScript Object Notation) format. For example, in the JSON format, it is defined what key is used to express a concept, and in the case where structuring is performed, an appropriate key for expressing the concept is selected. For example, in the case where “Memory” is defined as a key to express computer memory, the key (vocabulary) is unified with the expression “Memory” without using expressions such as “main memory apparatus” or “RAM.”

Furthermore, the assistance apparatus 10 generates a concrete draft system configuration to make the requirement information candidate (candidate for requirement definition that includes the component and/or performance indicator) feasible. For example, the assistance apparatus 10 generates and provides design information for the requirement information candidate to the user by specifically specifying a line system (for example, optical line, analog line, and so on), communication equipment to be used (router, hub, and so on), and so on.

The user reviews at least one or more provided requirement information candidates and corresponding design information. The user selects requirement information from among the provided requirement information candidate or modifies the requirement information candidate as necessary, and generates final requirement information (system requirement, requirement definition). Since a draft system request accompanied by the design information, and so on, which is based on the premise that the system will be realized, is provided to the user, the user can generate more accurate (appropriate) requirement information.

The configuration of the information processing system shown in FIG. 3 is an example and is not intended to limit the configuration of the authentication system. For example, the information processing system may include a plurality of the assistance apparatuses 10. Load balancing and redundancy may be achieved by a plurality of assistance apparatuses 10.

Next, details of the assistance apparatus 10 according to the first example embodiment will be described.

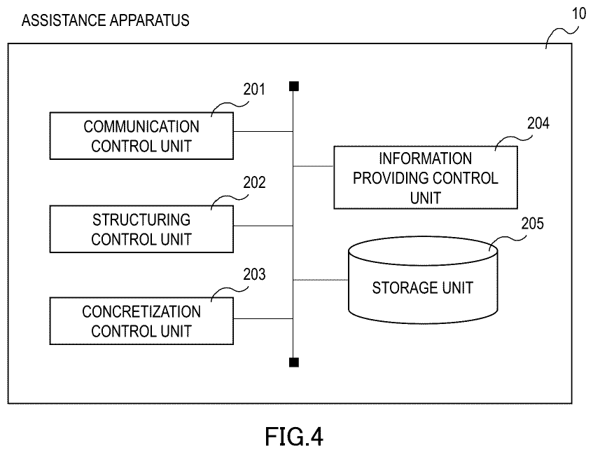

FIG. 4 is a diagram illustrating an example of a processing configuration (processing modules) of the assistance apparatus 10 according to the example embodiment of the present application. Referring to FIG. 4, the assistance apparatus 10 includes a communication control unit 201, a structuring control unit 202, a concretization control unit 203, an information providing control unit 204, and a storage unit 205.

The communication control unit 201 is means for controlling communication with other apparatuses. For example, the communication control unit 201 receives data (packets) from the terminal 20. In addition, the communication control unit 201 transmits data to the terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The structuring control unit 202 is means for performing control related to structuring a system request (request definition) acquired from a user. The structuring control unit 202 acquires request information described in a natural language and generates at least one or more requirement information candidates based on the acquired request information. Further, the structuring control unit 202 structures the generated at least one or more requirement information candidates.

Specifically, the structuring control unit 202 acquires a system request from the user (the terminal 20 of the user) who has accessed the assistance apparatus 10. For example, the structuring control unit 202 acquires the system request using a GUI (Graphical User Interface) or the like.

The structuring control unit 202 extracts an element (component and/or performance indicator) related to the system that is requested to be realized by the acquired system request. The structuring control unit 202 extracts the component and performance indicator from the system request using an arbitrary method.

For example, the structuring control unit 202 extracts the component, and so on by referring to table information that stores in association with each other a phrase that can be described in the system request and the element (component, performance indicator) that can be extracted from the phrase.

For example, by referring to the table information, the structuring control unit 202 extracts the component “network line” and the performance indicator “communication quality” from the phrase “video distribution system” described in the system request. Alternatively, the structuring control unit 202 extracts the component “distribution server” and the performance indicator “response time” from the “video distribution system.”

Alternatively, the structuring control unit 202 may extract the component and performance indicator by inputting the system request into a language model.

As an example, the language model may be, for example, what is referred to as a large-scale language model, but is not limited to this.

The language model is a machine learning model (also called a generative model) that inputs language and outputs language. The language model is trained on the relationships between words in a sentence, and is the model that generates a related character string from a target character string that is related to the target character string. By using the language model that has been trained on sentences and phrases in various contexts, it is possible to generate the related character string with appropriate content that is related to the target character string.

When the language model receives a prompt (query) that includes an instruction or the like related to a response, the language model outputs an answer corresponding to the prompt.

The learning method of the language model is not particularly limited, but as an example, the language model may be trained to output at least one sentence that includes the input character string. As a specific example, the language model is a GPT (Generative Pre-Transformer) that outputs a sentence including the input character string by predicting a character string that has a high probability of following the input character string.

Other examples of language models include, for example, T5 (Text-to-Text Transfer Transformer), BERT (Bidirectional Encoder Representations from Transformers), ROBERTa (Robustly optimized BERT approach), ELECTRA (Efficiently Learning an Encoder that Classifies Token Replacements Accurately), and so on.

A system administrator, or the like, prepares the language model to be implemented in the assistance apparatus 10 using a vast amount of design documents, specifications, and so on related to a system design.

For example, the structuring control unit 202 generates a prompt that includes a system request and an instruction to extract an element (component, performance indicator) from the system request. The structuring control unit 202 extracts the component and performance indicator by inputting the generated prompt into the language model.

Once the element (component, performance indicator) related to the system is extracted, the structuring control unit 202 generates a plurality of new elements (components, performance indicators) from a single element by “interpreting” each extracted element (component, performance indicator) from various perspectives.

For example, the structuring control unit 202 generates concrete components (a plurality of components) to realize the component from the extracted component. For example, the structuring control unit 202 generates the new plurality of components such as “fixed line” and “mobile line” from the component “network line.”

Alternatively, the structuring control unit 202 generates other components that are associated with the extracted component. For example, the structuring control unit 202 generates the new plurality of components such as the component “transmitting server” and the component “receiving terminal”, which are associated with the component “network line.”

Alternatively, the structuring control unit 202 generates a plurality of performance indicators by reducing the extracted performance indicator to a specific numerical value. For example, the structuring control unit 202 generates the plurality of performance indicators such as “10 Mbps”, “100 Mbps”, and “1 Gbps” from the performance indicator “communication quality.”

Alternatively, the structuring control unit 202 may generate a plurality of components and a plurality of performance indicators using a plurality of documents related to requirement definition as input (using a plurality of documents). For example, the structuring control unit 202 may generate the plurality of components and performance indicators with different interpretations from the extracted components and performance indicators using the plurality of documents with different guidelines for the requirement definition.

The structuring control unit 202 may generate a plurality of elements by referring to table information that stores in association with each other the element (component, performance indicator) extracted from a system request and a plurality of other elements (components, performance indicators). The system administrator, or the engineer, or the like, generates the above table information so that the plurality of elements are generated from a single element from a plurality of perspectives, different perspectives, and so on. It is preferable that the system administrator, or the like, generate the above table information so as to cover other elements that can be generated from the single element.

Alternatively, the structuring control unit 202 may generate the plurality of elements from each of the elements using the language model.

For example, the structuring control unit 202 generates a prompt that includes an instruction to generate other elements (a plurality of other elements) from an element extracted from a system request. For example, the structuring control unit 202 generates the prompt “Please generate two or more components and performance indicators related to LABEL1.” and acquires a plurality of elements by inputting the generated prompts into the language model.

The extracted element is set to LABEL1 described in the above prompt. For example, in the above example, phrases such as “network line” and “communication quality” are set to LABEL1.

Note, of course, that the prompt to be input into the language model is not limited to the above examples.

For example, the structuring control unit 202 may acquire a plurality of elements from a single element by generating a plurality of prompts with different instruction content and inputting each prompt into the language model. For example, the structuring control unit 202 may generate a plurality of prompts that include an instruction to output the element with a different perspective with respect to the element extracted from the system request. Alternatively, the structuring control unit 202 may generate a plurality of prompts that have the same meaning but have a different expression.

For example, the structuring control unit 202 may generate the prompt that includes an instruction to output the component that focus on cost or the performance indicator that focus on performance. In the former case, for example, the prompt such as “Please select a plurality of parts with respect to LABE1, prioritizing cost.” is provided as an example. In the latter case, for example, the prompt such as “Please select a plurality of parts with respect to LABE1, prioritizing performance.” is provided as an example.

Once a new plurality of elements are acquired with respect to each element (configuration requirement, performance indicator) extracted from the system request, the structuring control unit 202 combines the plurality of elements to generate a plurality of requirement information candidates.

For example, the structuring control unit 202 generates the plurality of requirement information candidates by combining the component “fixed line” and the component “mobile line” acquired from the component “network line” and the performance indicator “10 Mbps” and the performance indicator “100 Mbps” acquired from the performance indicator “communication quality.” In this case, the following four requirement information candidates are generated.

Requirement information candidate 1=“Network line; fixed line, communication quality; 10 Mbps”.
Requirement information candidate 2=“Network line: fixed line; communication quality: 100 Mbps”.
Requirement information candidate 3=“Network line; mobile line; communication quality; 10 Mbps”.
Requirement information candidate 4=“Network line; mobile line; communication quality; 100 Mbps”.

Note that, for ease of understanding, an example is given of four requirement information candidates that include the single component and a corresponding performance indicator, but in reality, requirement information candidates consisting of plurality of components and a plurality of performance indicators can be generated. For example, a requirement information candidate with contents such as “network line; fixed line, communication quality; 10 Mbps, delivery server; physical machine, response time; 5 ms” can be generated.

After the structuring control unit 202 generates the plurality of requirement information candidates, the structuring control unit 202 structures each of the plurality of requirement information candidates. The structuring control unit 202 converts each requirement information candidate into requirement information (requirement information candidate) that have a predetermined structure.

For example, the structuring control unit 202 acquires the corresponding structured requirement information candidate by sequentially inputting each requirement information candidate into the language model. For example, the structuring control unit 202 acquires the corresponding structured requirement information candidate by inputting a query into the language model with content such as “Please convert the requirement information for LABEL2 to JSON format.” Note that specific contents such as those shown in the above requirement information candidates 1 through 4 are set for LABEL2.

The structuring control unit 202 generates a plurality of structured requirement information candidates by sequentially converting the plurality of requirement information candidates using the language model.

The structuring control unit 202 hands over at least one or more structured requirement information candidates to the concretization control unit 203.

In this way, the structuring control unit 202 generates at least one or more requirement information candidates (a group of requirement candidates) from the request information (system request, system requirement definition) described in a natural language. At that time, the structuring control unit 202 generates a plurality of new elements corresponding to each element by interpreting each element included in the acquired request information from a different perspective. The structuring control unit 202 generates at least one or more requirement information candidates by combining the generated plurality of new elements. The structuring control unit 202 structures each generated requirement information candidate. Specifically, the structuring control unit 202 converts each requirement information candidate into a requirement information candidate described in a predetermined format (grammar and vocabulary).

The concretization control unit 203 is means for performing control related to concretization of the requirement information candidate (generating a concrete draft design). The concretization control unit 203 concretizes at least one or more structured requirement information candidates.

The concretization control unit 203 generates concrete design information with respect to each requirement information candidate (structured requirement information candidate) using any means. The concretization control unit 203 narrows down an optimal system configuration from among a plurality of system configurations acquired by concretizing the component and performance indicator included in the requirement information candidate, and generates the narrowed-down system configuration as design information.

For example, the concretization control unit 203 generates the concrete design information using various algorithms related to a multi-objective optimization problem. The requirement information candidate handled by the concretization control unit 203 is structured to enable mechanical processing. Therefore, the concretization control unit 203 can generate the concrete design information by applying the algorithms for solving the multi-objective optimization problem to the structured requirement information candidate.

At that time, the concretization control unit 203 may generate the concrete design information for the structured requirement information candidate using technical information prepared in advance.

The technical information includes a list of parts that may be employed in a system (a list that includes a performance indicator and price of available parts, and so on), and general technical common knowledge (general constraint; for example, maximum length of a LAN (Local Area Network) cable, and so on).

The concretization control unit 203 uses the technical information, and so on, to generate the concrete design information for each requirement information candidate from the perspectives of system reliability, system consistency, and appropriateness of cost required for system construction, and so on.

For example, with respect to the system consistency, the concretization control unit 203 selects a part that satisfy the structured requirement information candidate from the list of available parts, and determines that the structured requirement information candidate is feasible if there is a combination of parts that satisfy all the requirements (objectives). The concretization control unit 203 employs the combination of parts that is determined to be feasible as the concrete design information of the requirement information candidate.

On the other hand, if there is no combination of parts that satisfies all the requirements, the concretization control unit 203 determines that the requirement information candidate is not feasible.

Alternatively, the concretization control unit 203 generates the concrete design information for the requirement information candidate by using the technical information and the performance indicator described in the structured requirement information candidate. The concretization control unit 203 refers to cost and performance of the part described in the technical information, or to technical common knowledge, and determines that the design information cannot be generated with respect to the requirement information candidate that requires extremely low cost, extremely high performance, or is physically not feasible to achieve.

In this way, the concretization control unit 203 determines that the requirement information candidate that has acquired the concrete system configuration that optimizes at least one or more example, objectives (for reliability, consistency, and cost reasonableness of the system) is “feasible.”

Note that the algorithm for solving the multi-objective optimization problem is different from the purpose of the present application so a detailed description will be omitted.

Alternatively, the concretization control unit 203 may utilize the automated design technology disclosed in Reference Document 1 below, which is specialized for system development, to determine whether each requirement information candidate is feasible or not and to generate concrete design information.

Reference Document: Japanese Unexamined Patent Application Publication No. JP2021-135625

Reference Document 1 discloses a technique for generating concretized design information by repeating an operation that progressively concretizes an abstract system configuration included in a given system requirement.

Automated design algorithm disclosed in Reference Document 1 targets configuration information, such as requirement described in a predetermined format, for concretization. The configuration information is described by a plurality of components and relationships among the components. For example, in the configuration information, the configuration element is expressed as a node in a graph, and a relationship among configuration elements is expressed as an edge in a graph. Each configuration element and relationship includes a unique ID, a type that represents its type, an attribute value, and so on.

In the case where the element (the component and the relationship among the components) is abstract, the automated design algorithm uses a concretization rule that defines an option for a method of realization that realizes the abstract element (concretization method). Furthermore, the automatic design algorithm derives a design draft by taking the configuration information (requirements to be concretized) as an input and concretizing the input in a stepwise and searching manner. A search tree with a tree structure is formed by recording the path of the search. A node of the search tree (node) corresponds to either a requirement, a draft configuration, or a design result, and a branch (edge) corresponds to a one-step concretization operation that generates the draft configuration from the requirement or generates other draft configuration or design result from the draft configuration.

The automated design algorithm performs a search processing that takes an input requirement (requirement information) as an initial state and a concrete design result as a target state. The automated design algorithm selects a state corresponding to a promising draft configuration and repeats the processing of generating a plurality of next states by concretizing the draft configuration, until a concrete configuration is acquired. Once the automated design algorithm first acquires the concrete draft configuration, the automated design algorithm outputs the concrete draft configuration as the design result (design information).

Note that the automated design algorithm (automated design technology) is different from the purpose of the present application, so a more detailed description will be omitted.

The concretization control unit 203 uses the technology disclosed in Reference Document 1 to determine that the requirement information candidate is feasible if the design information (system configuration) corresponding to the requirement information candidate is acquired. On the other hand, the concretization control unit 203 determines that the requirement information candidate is not feasible if the design information corresponding to the requirement information candidate is not acquired.

In this way, with respect to each requirement information candidate, the concretization control unit 203 determines whether or not each requirement information candidate is feasible. With respect to each requirement information candidate, the concretization control unit 203 hands over the result of determination of whether or not each requirement information candidate is feasible and the concrete design information if feasible to the information providing control unit 204.

Note that regardless of whether the algorithm for solving the multi-objective optimization problem or the automated design algorithm is used, the requirement information candidate that has no errors or contradictions among elements (component and performance indicator) will be determined to be “feasible.” In other words, in the process of generating concrete design information related to each requirement information candidate, the concretization control unit 203 eliminates the requirement information candidate with an error in content or a contradiction among elements, and selects the requirement information candidate with no deficiencies from among the plurality of requirement information candidates.

For example, in the case where a solution (design information) is not output because the performance indicator in the requirement information candidate is inconsistent, it is interpreted that the requirement information candidate has a problem from the perspectives of consistency and reliability.

The concretization control unit 203 hands over the selected requirement information candidate and corresponding design information, and so on, to the information providing control unit 204.

For example, consider a case in which, among the four requirement information candidates mentioned above, design information (reasonable design information in terms of cost, and so on) to achieve a communication speed of 100 Mbps on a mobile line is not acquired for Requirement Information Candidate 4, but design information is acquired for the other requirement information candidates. In this case, Requirement Information Candidates 1-3 are handed over to the information providing control unit 204 as feasible requirement information candidates.

In this way, the concretization control unit 203 generates design information for at least one or more requirement information candidates by concretizing at least one or more structured requirement information candidates. In other words, the concretization control unit 203 determines the feasibility of each of the at least one or more structured requirement information candidates by attempting to concretize each of the at least one or more structured requirement information candidates.

The information providing control unit 204 is means for controlling providing information to a user. The information providing control unit 204 provides information acquired from the concretization control unit 203 (information acquired by concretization of requirement information candidate) to the user.

More specifically, the information providing control unit 204 presents the design information, and so on, acquired by the concretization of the concretization control unit 203 to the user, and requests the user to check the design information, and so on, presented to the user. For example, the information providing control unit 204 provides the user with information related to the requirement information candidate that is determined to be feasible among the plurality of requirement information candidates.

For example, the information providing control unit 204 displays on the terminal 20 the system request input by the user and the design information corresponding to the candidate requirement information that is determined to be “feasible” among a plurality of requirement information candidates generated from the system request.

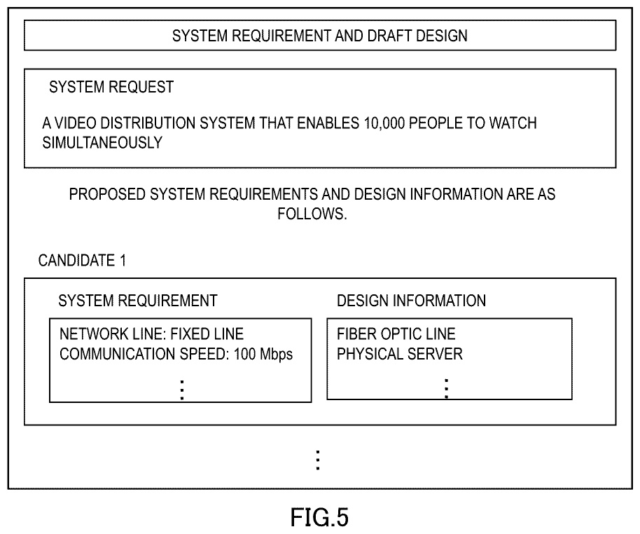

For example, the information providing control unit 204 displays a screen on the terminal 20 as shown in FIG. 5.

In this way, the information providing control unit 204 provides the design information, and so on generated by the concretization control unit 203 to the user. Specifically, the information providing control unit 204 provides the user with the requirement information candidate that is determined to be feasible and the corresponding design information out of at least one or more structured requirement information candidates.

Note that there may be cases in which the requirement information candidate that is determined to be “feasible” by the concretization control unit 203 does not exist. In this case, the information providing control unit 204 may notify the user of the fact (non-existence of the requirement information candidate that is determined to be feasible). In other words, in the case where the requirement information candidate that is determined to be feasible does not exist, the information providing control unit 204 may notify the user of the non-existence of feasible design information.

The storage unit 205 is means for storing information necessary for an operation of the assistance apparatus 10.

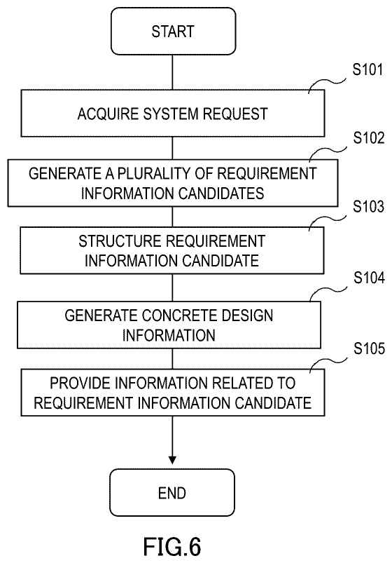

The operation of the assistance apparatus 10 is summarized in a flowchart shown in FIG. 6.

The structuring control unit 202 of the assistance apparatus 10 acquires a system request from a user (step S101).

The structuring control unit 202 generates a plurality of requirement information candidates from the acquired system request (step S102). Specifically, the structuring control unit 202 extracts a component and a performance indicator from the system request, and generates a plurality of new elements with respect to each of the extracted elements. The structuring control unit 202 generates a plurality of requirement information candidates by combining the plurality of elements acquired from each element.

The structuring control unit 202 structures the generated plurality of requirement information candidates (step S103). For example, the structuring control unit 202 instructs the language model to convert each requirement information candidate into a predetermined format (for example, JSON format) to acquire the structured requirement information candidates.

The concretization control unit 203 generates concrete design information with respect to each structured requirement information candidate (step S104). The concretization control unit 203 determines that the requirement information candidate for which concrete design information can be acquired is “feasible.” The concretization control unit 203 determines that the requirement information candidate for which no concrete design information can be acquired is “not feasible.”

The information providing control unit 204 provides information related to the requirement information candidate that is determined to be feasible (Step S105).

Next, the operation of the assistance apparatus 10 will be described from the perspective of data (information) handled by the assistance apparatus 10.

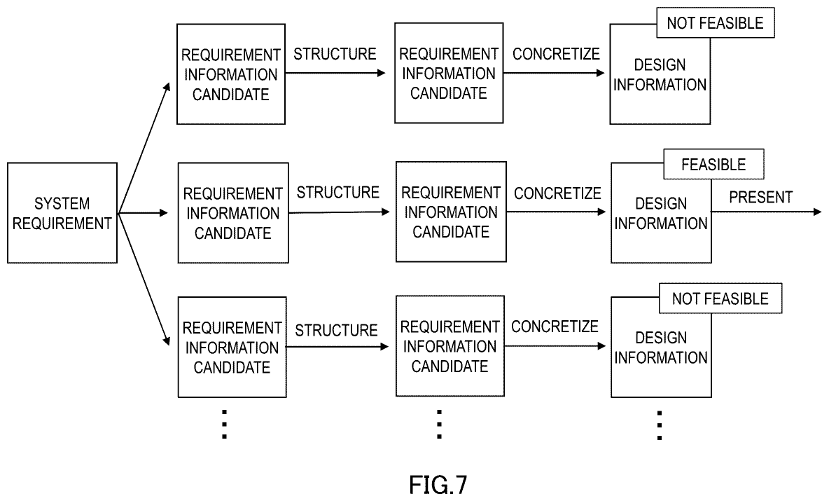

As shown in FIG. 7, a plurality of requirement information candidates are generated from a system request. The plurality of requirement information candidates are structured. An attempt is made to concretize each structured requirement information candidate using an algorithm that solves a multi-objective optimization problem, and so on. At that time, the requirement information candidate with an error in content or a contradiction among elements (component elements, performance indicators) is determined to be “not feasible.” The requirement information candidate that is determined to be “feasible” is presented to the user.

### Terminal

A detailed description of the terminal 20 will be omitted. Examples of the terminal 20 include a portable terminal device such as a smartphone, a portable phone, a game console, or a tablet and a computer (a personal computer or a laptop computer). The terminal 20 can be any equipment or device as long as the terminal 20 can accept an operation by a user and can communicate the assistance apparatus 10.

Next, variations according to the first example embodiment will be described.

### Variation 1

In the case where there are plurality of requirement information candidates that are determined to be feasible, the concretization control unit 203 may assign priorities to the plurality of requirement information candidates. For example, the concretization control unit 203 calculates a score with respect to each requirement information candidate that is determined to be feasible, from the perspectives of cost and performance.

For example, the concretization control unit 203 calculates the cost required to realize the requirement information candidate by adding up a price of each part employed in the generated design information. The concretization control unit 203 assigns a higher score to the requirement information candidate with the lower cost.

Alternatively, the concretization control unit 203 calculates a performance indicator for a system that is realized by the generated design information. For example, the concretization control unit 203 calculates the performance indicator of the above system based on a specification related to a performance of the employed part. For example, in the case of a communication system, the slowest communication speed among communication speeds of each component that constitutes the communication system (network line, router, hub, access point, receiving terminal, and so on) is calculated as the performance indicator of the system (performance indicator related to communication speed). The concretization control unit 203 assigns a higher score to the requirement information candidate with a higher performance indicator.

The concretization control unit 203 assigns a priority to each requirement information candidate based on the calculated score (for example, a score related to cost, a score related to performance, or a total value of the scores related to the cost and performance, and so on). The concretization control unit 203 assigns a higher priority to the requirement information candidate with a higher score. The concretization control unit 203 treats the requirement information candidate with the higher priority (score) as the requirement information candidate that has a higher feasibility.

With respect to each requirement information candidate that is determined to be feasible, the concretization control unit 203 may hand over associated information along with specific design information to the information providing control unit 204. For example, the concretization control unit 203 may hand over information such as the above calculated score and priority to the information providing control unit 204 as associated information with the design information.

The information providing control unit 204 may provide information related to the requirement information candidate using the associated information as well as the design information, and so on. For example, the information providing control unit 204 selects the requirement information candidate with the higher priority and presents the requirement information candidate to the user.

In this way, the concretization control unit 203 may calculate a score with respect to each of at least one or more structured requirement information candidates from a predetermined perspective. The information providing control unit 204 may determine (select) information to be provided to the user based on the score of each of at least one or more structured requirement information candidates.

### Variation 2

The assistance apparatus 10 may accept a modification of a system request from a user and provide the user with a requirement information candidate, design information, and associated information, and so on, in accordance with the accepted system request. In this case, the concretization control unit 203 stores the system request input by the user and the generated requirement information candidate, design information, and so on in association with each other.

The concretization control unit 203 generates the requirement information candidate, design information, and so on based on the system request newly input by the user. The concretization control unit 203 hands over the new system request, requirement information candidate, design information, and so on, as well as the above stored system request, requirement information candidate, design information, and so on, to the information providing control unit 204.

For example, the information providing control unit 204 may summarize or highlight the design information, and so on generated based on the new system request, and provide the design information to the user.

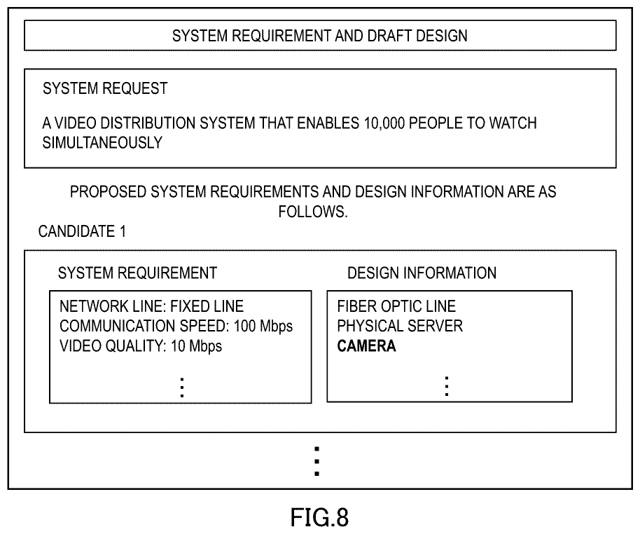

Alternatively, the information providing control unit 204 may extract a difference in the acquired design information, and so on, and provide the newly generated design information to the user while highlighting the extracted difference. Alternatively, the information providing control unit 204 may summarize (summarize using the language model), highlight, or excerpt or the like the newly generated design information, and so on. For example, as shown in FIG. 8, the information providing control unit 204 may highlight a newly added part, and so on to the design information by displaying the newly added part, and so on in bold type.

In this way, the information providing control unit 204 may provide the user with a result of performing at least one of the processing of summarizing, processing of excerpting, and processing of highlighting all or part of the design information, and so on.

### Variation 3

In the above example embodiment, the case where the information providing control unit 204 notifies the fact to the user in the case where the requirement information candidate that is determined to be “feasible” cannot be acquired is described. However, in such case, the assistance apparatus 10 regenerates the requirement information candidate by deleting a part of the requirements included in each requirement information candidate, and so on. The assistance apparatus 10 may re-perform a processing of concretization by using the re-generated requirement information candidate.

For example, in the case where it is determined that the requirement information candidate that includes requirements A to E is “not feasible,” the concretization control unit 203 deletes one of the requirements A to E and generates a new requirement information candidate. For example, the concretization control unit 203 generates the requirement information candidate that includes requirements A to D. The concretization control unit 203 re-performs the processing of concretization of the generated requirement information candidate.

In the case where a requirement information candidate that is determined to be “feasible” cannot be acquired by deleting the requirements (by deleting any of A to E above), the concretization control unit 203 may generate a new requirement information candidate by increasing the number of requirements to be deleted, and perform the processing of concretization on the new requirement information candidate that has been generated. For example, the concretization control unit 203 may perform the processing of concretization with respect to the requirement information candidate that includes requirements A to C, and determine whether the new requirement information candidate is feasible or not.

The concretization control unit 203 can acquire the requirement information candidate that is determined to be feasible by repeating the deletion of the requirement and the processing of concretization with respect to the new requirement information candidate. In particular, the concretization control unit 203 can acquire the requirement information candidate for which a contradictory requirement has been deleted (the requirement information candidate that is determined to be feasible) by repeating the above deletion of the requirement and the processing of concretization with respect to each of the plurality of requirement information candidates generated by the structuring control unit 202.

The concretization control unit 203 hands over the requirement information candidate that is determined to be feasible to the information providing control unit 204. The information providing control unit 204 provides the acquired requirement information candidates to the user. Moreover, the concretization control unit 203 may provide information related to the deleted requirement to the user via the information providing control unit 204 to acquire the requirement information candidate that is determined to be feasible. Alternatively, at the time of assigning a score to the requirement information candidate, the concretization control unit 203 may assign a higher score to the requirement information candidate with fewer deleted requirements.

As described above, the assistance apparatus 10 according to the first example embodiment acquires a system request from a user and generates a plurality of candidates of requirement information from the acquired system request. The assistance apparatus 10 converts each of the plurality of requirement information candidates into a format that can be processed by a machine, and generates a structured requirement information candidate. The assistance apparatus 10 determines a feasibility of each of structured requirement information candidates in a process of verifying concretization of each of the plurality of structured requirement information candidates with respect to each of the plurality of structured requirement information candidates. Furthermore, the assistance apparatus 10 acquires corresponding design information (draft system configuration) by concretizing each requirement information candidate. The assistance apparatus 10 provides the requirement information that is determined to be feasible (requirement information candidates for which a concrete draft design has been acquired) and the corresponding design information to the user. The user can generate more accurate requirement information (requirement definition) by verifying the provided requirement information and design information.

Here, it is assumed that the system request acquired by the assistance apparatus 10 includes various deficiencies. Specifically, it is assumed that the system request lacks information necessary for a system design or includes a contradiction. The assistance apparatus 10 acquires the system request that includes various problems, and so on, and generates the requirement information to be used in a subsequent process (requirement definition process) based on the acquired system request. For example, the assistance apparatus 10 generates the requirement definition that includes information related to the component (hardware, software) of the system that is requested to be realized by the system request and the performance indicator related to a performance of the system, and so on.

Furthermore, the assistance apparatus 10 acquires the system request that has a variety of vocabulary and expression methods (system request that is easily understood by a human). In other words, the assistance apparatus 10 acquires the system request that has a large diversity of expressions and is an unstructured expression. The assistance apparatus 10 generates the requirement Information candidate based on the acquired system request. The assistance apparatus 10 converts the generated requirement information candidate into a format in which the vocabulary and expression methods are strictly defined (a format that can be handled by the algorithm for the multi-objective optimization problem, and so on). That is, the assistance apparatus 10 generates a structured representation of requirement information candidate with a small diversity of expressions. By generating the structured requirement information candidate, various algorithms can be easily applied.

### Second Example Embodiment

Next, a second example embodiment will be described in detail with reference to drawings.

The second example embodiment describes a case in which the assistance apparatus 10 uses a past design document of a system that has been designed in the past, a guideline related to the system to be designed, a standard specification, and so on, to verify the requirement information candidate (generate concrete design information).

As the information processing system according to the second example embodiment can have the same configuration as that according to the first example embodiment, the description corresponding to FIG. 3 will be omitted.

The following description will be made with a focus on the difference between the first example embodiment and the second example embodiment.

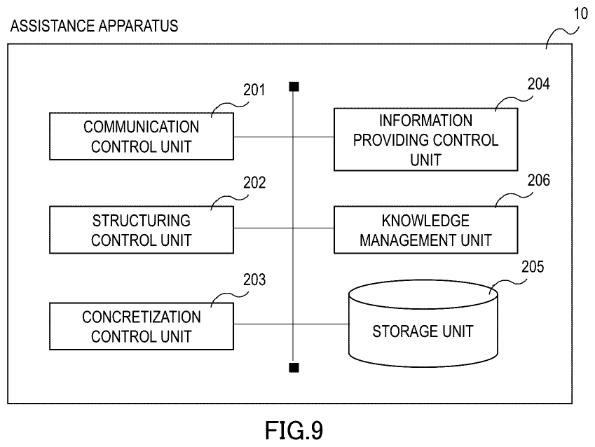

FIG. 9 is a diagram illustrating an example of a processing configuration (processing modules) of the assistance apparatus 10 according to an example embodiment of the present application. Referring to FIG. 9, a knowledge management unit 206 is added to the configuration of the assistance apparatus 10 according to the first example embodiment.

The knowledge management unit 206 is means for performing control and management related to the above mentioned past design document, guideline, standard specification, product catalog, and so on. The knowledge management unit 206 structures past know-how, technical common knowledge, or the like in system design.

The knowledge management unit 206 acquires the past design document, and so on as “system design information.” For example, a system administrator, or the like, inputs the past design document, and so on, to the assistance apparatus 10 as the system design information.

The knowledge management unit 206 extracts information such as constraints in system design, technical common knowledge, rules of thumb, and so on as “knowledge information” from the acquired system design information.

For example, from the past design document, frequently used component, performance indicator, parameter setting, or a combination of these can be acquired as the knowledge information. Alternatively, from the guideline or standard specification, the component, performance indicator, parameter setting, or a combination of these that is recommended for use can be acquired as the knowledge information. Alternatively, from a product catalog, cost and performance of a part can be acquired as the knowledge information.

In other words, the knowledge management unit 206 extracts know-how such as the constraints in the system design, technical common knowledge, and so on as the knowledge information from the past design document, and so on. For example, the knowledge management unit 206 extracts knowledge information by inputting the acquired system design information into the language model along with an appropriate instruction.

For example, the knowledge management unit 206 extracts constraint information related to a part used in the system and a system performance.

For example, the knowledge management unit 206 extracts information related to the cost of the part and the performance constraint from a product catalog. For example, the knowledge management unit 206 extracts the constraint information such as “The price of the camera should be less than or equal to A yen”, “There are no cameras with a resolution of more than B pixels”, and “There are no cameras that cost less than or equal to C yen and have a resolution of D pixels or higher.”

Alternatively, the knowledge management unit 206 extracts the constraint related to the system performance (constraint information). For example, the knowledge management unit 206 extracts information related to the performance (for example, video quality and communication latency) that is difficult to achieve simultaneously in the system as the constraint information. For example, the knowledge management unit 206 extracts the constraint information such as “video quality of 10 Mbps or higher and communication latency of 5 ms or less are difficult to achieve simultaneously.

Alternatively, the knowledge management unit 206 extracts standard information related to standards for the part and system performance.

For example, the knowledge management unit 206 extracts a standard part that is often employed in the system as the standard information. Alternatively, the knowledge management unit 206 extracts the performance that is considered standard in the system (for example, a communication speed of 100 Mbps or less is standard) as the standard information.

The knowledge management unit 206 structures the acquired knowledge information and stores the acquired knowledge information in the storage unit 205. The knowledge management unit 206 converts the acquired knowledge information into a format that can be referenced by the concretization control unit 203. For example, the knowledge management unit 206 structures the knowledge information by inputting the knowledge information into the language model along with an appropriate instruction.

Note that an engineer, or the like may generate the knowledge information, and register the generated knowledge information in the assistance apparatus 10. Alternatively, the engineer, or the like may register the structured knowledge information in the assistance apparatus 10. The knowledge management unit 206 may store the structured knowledge information in the storage unit 205 using any means.

In this way, the knowledge management unit 206 acquires information related to the system design as the system design information and extracts know-how, and so on, in the system design from the acquired system design information as the knowledge information. The knowledge management unit 206 structures the extracted knowledge information and stores the extracted knowledge information in the storage unit 205.

The concretization control unit 203 according to the second example embodiment can concretize at least one or more structured requirement information candidates using the structured knowledge information. In other words, the concretization control unit 203 determines the feasibility of the requirement information candidate (generating concrete design information) using the knowledge information stored in the storage unit 205.

In this way, the concretization control unit 203 may generate specific design information for each requirement information candidate using not only general technical information but also knowledge information specific to the target system. As a result, the concretization control unit 203 can generate more accurate design information.

Next, variations according to the second example embodiment will be described.

### Variation 1

The concretization control unit 203 may add a predetermined constraint or new component to the requirement information candidate that is determined to be not feasible (requirement information candidate for which no concrete design information has been acquired) and determine whether the requirement information candidate is feasible or not. At that time, the concretization control unit 203 may determine the above predetermined constraint or component to be added based on the knowledge information.

For example, with respect to the requirement information candidate of “video quality of 10 Mbps or higher and communication latency of 1 ms or lower”, in the case where the general technical information is used, consider the case where it is determined that the requirement information candidate is not feasible. In this case, the concretization control unit 203 refers to the constraint information related to performance in the knowledge information, “It is difficult to achieve both video quality of 10 Mbps or higher and communication latency of 5 ms or lower”, and adds a constraint (modification) to the above requirement information candidate.

For example, the concretization control unit 203 adds a constraint to the performance indicator “communication latency”, such as “communication latency 5 ms or less.” The concretization control unit 203 determines whether or not the candidate requirement information to which the constraint is added can be feasible (whether or not concrete design information can be generated).

Alternatively, the concretization control unit 203 may add new component acquired from the knowledge information to the requirement information candidate that is determined to be not feasible, and determine whether the above requirement information candidate is feasible or not.

If concrete design information is acquired, the concretization control unit 203 sets the requirement information candidate before the constraint information is added as a “conditional requirement information candidate.” If concrete design information is not acquired even after adding the constraint and component, the concretization control unit 203 treats the requirement information candidate before the constraint, and so on are added as not feasible.

In this way, the concretization control unit 203 may add the predetermined constraint or component to the requirement information candidate and determine whether or not the requirement information candidate is feasible. With respect to the requirement information candidate that is determined to be feasible by adding the predetermined constraint, and so on, the concretization control unit 203 considers that the added constraint or component is lacking.

Note that with respect to the requirement information candidate that is determined to be not feasible even after adding the constraint, and so on, the concretization control unit 203 may determine that there is an error in the selection of the constraint, and so on, to be added. In this case, the concretization control unit 203 may determine whether the requirement information candidate is feasible or not by adding the constraint or component from the other perspective to the requirement information candidate, instead of the constraint, and so on that have already been added.

The concretization control unit 203 hands over the generated conditional requirement information candidate and corresponding design information, and so on, to the information providing control unit 204.

In the case where the information providing control unit 204 acquires the conditional requirement information candidate, the information providing control unit 204 may present the conditional requirement information candidate and the design information to the user in a manner that the user can distinguish the conditional requirement information candidate and the design information from the normal requirement information candidate.

In this way, the concretization control unit 203 may add the constraint or component acquired from the knowledge information to at least one or more structured requirement information candidates, and concretize at least one or more structured requirement information candidates to which the constraint or component has been added.

### Variation 2

The information providing control unit 204 may reflect whether or not the constraint, and so on is added to the requirement information candidate and the content of the addition in the score (priority). Specifically, the information providing control unit 204 may assign a lower score to the requirement information candidate to which many constraints, and so on, are added. Alternatively, the information providing control unit 204 may provide a weight to the added content and assign a score to the requirement information candidate.

Alternatively, the information providing control unit 204 may assign a score to the requirement information candidate using the knowledge information (the past design document, guideline (security guideline), information acquired from the standard specification, and so on). For example, the information providing control unit 204 assigns a higher score to the requirement information candidate that employs the component that has been used more frequently in past designs. Alternatively, the information providing control unit 204 assigns a higher score to the requirement information candidate that employs the component that has been used more recently in past designs. Alternatively, the information providing control unit 204 assigns a higher score to the requirement information candidate that employs the component that is recommended to be used in the security guideline or standard specification. On the other hand, a lower score is assigned to the requirement information candidate that employs the component that is recommended not to be used in the security guideline, and so on.

As described above, the assistance apparatus 10 according to the second example embodiment may generate the knowledge information using the system design information such as the past design document, guideline, standard specification, and so on. By using the knowledge information to concretize the requirement information candidate, the assistance apparatus 10 can more accurately determine whether the requirement information candidate is feasible or not.

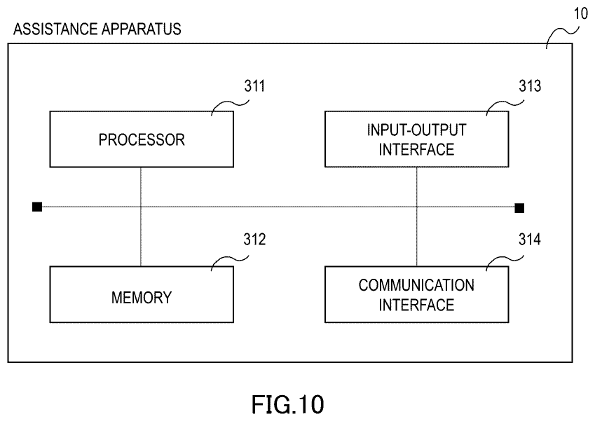

Next, a hardware configuration of an individual apparatus that constitutes the information processing system will be described. FIG. 10 is a diagram illustrating an example of a hardware configuration of the assistance apparatus 10.

The assistance apparatus 10 can be configured by an information processing apparatus (a so-called computer) and has a configuration illustrated as an example in FIG. 10. For example, the assistance apparatus 10 includes a processor 311, a memory 312, an input-output interface 313, a communication interface 314, and so on. The components such as the processor 311 are connected to an internal bus, and so on so that these components can communicate with each other.

The hardware configuration of the assistance apparatus 10 is not limited to the configuration illustrated in FIG. 10. The assistance apparatus 10 may include hardware not illustrated or may be configured without the input-output interface 313 if desired. In addition, the number of components, such as the number of processors 311, included in the assistance apparatus 10 is not limited to the example illustrated in FIG. 10. For example, a plurality of processors 311 may be included in the assistance apparatus 10.

The processor 311 is a programmable device such as a CPU (Central Processing Unit), an MPU (Micro Processing Unit), a DSP (Digital Signal Processor), a TPU (Tensor Processing Unit), a GPU (Graphics Processing Unit (GPU), or the like. Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. For example, the display apparatus is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the assistance apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the terminal 20 can be configured by an information processing apparatus, and the basic hardware configuration of the terminal 20 is the same as that of the assistance apparatus 10. Thus, description of the basic hardware configuration of the terminal 20 will be omitted.

The assistance apparatus 10, which is an information processing device includes a computer and can realize its functions by causing the computer to execute a program. In addition, the assistance apparatus 10 executes a control method of the assistance apparatus 10 by using this program.

### Variations

The configurations, operations, and so on of the information processing system according to the above example embodiments are examples and do not limit the present system configuration, and so on.

In the above example embodiments, the case in which the assistance apparatus 10 extracts a plurality of elements from the system request, and after that, generates new plurality of elements by interpreting the extracted elements from the various perspectives, is described. However, the assistance apparatus 10 may acquire the above new plurality of elements directly from the system request by inputting the system request and an appropriate prompt into the language model.

The assistance apparatus 10 may generate the requirement information candidate using the knowledge information generated from the system design information. In other words, the assistance apparatus 10 may incorporate the component or constraint that is essential to the system design into the requirement information candidate in advance by referring to the knowledge information.

The assistance apparatus 10 may perform concretization of the requirement information candidate using the language model instead of or in addition to an algorithm for solving a multi-objective optimization problem or an automated design algorithm. For example, the assistance apparatus 10 may generate a prompt that includes the requirement information candidate, and an instruction related to generating a concrete configuration draft of the requirement information candidate, and acquire the concrete configuration draft by inputting the prompt into the language model.

In the above example embodiments, taking the JSON format as an example, the case in which the assistance apparatus 10 structures the requirement information candidate and knowledge information is described. However, it goes without saying that the assistance apparatus 10 may also convert the requirement information candidate, and so on, into other formats. For example, the assistance apparatus 10 may convert the requirement information candidates to RDF (Resource Description Framework) format or XML (Extensible Markup Language) format. The assistance apparatus 10 may convert the requirement information candidates into any machine-processable format and structure the requirement information candidate.

The assistance apparatus 10 may acquire an input system request (request information) from the user using voice recognition technology. Specifically, the structuring control unit 202 acquires voice data via a microphone equipped with the terminal 20. The structuring control unit 202 acquires a system request in text form by applying voice recognition technology to the voice data.

The assistance apparatus 10 is capable of accepting the system request in any format. For example, the assistance apparatus 10 acquires the system requirement described in spoken language such as minutes of a meeting, or the system request such as a draft of the requirement definition. In other words, there is no restriction on the format (form, format) of the system request acquired by the assistance apparatus 10.

The assistance apparatus 10 may acquire the system request using technology related to generating minutes. For example, the structuring control unit 202 generates the minutes from text data and voice data related to a meeting between a vendor company and a client company. The structuring control unit 202 may treat the generated minutes as the system request. Alternatively, the assistance apparatus 10 may generate (acquire) the system request by utilizing the learning model such that a summary is generated from the minutes, as necessary.

In the above example embodiments, an example has been described in which the language model is implemented in the assistance apparatus 10. However, the language model may be implemented in a server or the like that is different from the assistance apparatus 10. In this case, the assistance apparatus 10 generates a prompt to be input to the language model and transmits the generated prompt to an external server (a server on which the language model is implemented). The assistance apparatus 10 may acquire an output of the language model (for example, structured requirement information candidate, and so on) from the external server.

The assistance apparatus 10 may retain the general technical information and knowledge information for each technical field (for each type of system). For example, the assistance apparatus 10 may store the technical information and knowledge information for each system, such as an information distribution system, an online conference system, and a face recognition system. Note that in this case, before the assistance apparatus 10 provides a service to the user, the assistance apparatus 10 may acquire a type of system, and so on to be designed by the user, and generate the design information and so on in accordance with the acquired system.

In the above example embodiments, an example has been described in which the assistance apparatus 10 is realized as a server in a server-client system. However, the assistance apparatus 10 may also be realized by the terminal 20 of a user in which a predetermined application is installed.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed.

In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information processing systems and so on that assist users in system design.

A part or the entirety of the example embodiments described above may be described as in the following supplementary notes, but is not limited to the followings.

### Supplementary Note 1

An information processing apparatus, including: a structuring control means that acquires request information described in a natural language, generates at least one or more requirement information candidates based on the acquired request information, and structures the generated at least one or more requirement information candidates; and a concretization control means that concretizes the at least one or more structured requirement information candidates.

### Supplementary Note 2

The information processing apparatus according to supplementary note 1, further including an information providing control means that provides information acquired by concretization of the at least one or more structured requirement information candidates to a user.

### Supplementary Note 3

The information processing apparatus according to supplementary note 2, wherein the concretization control means generates design information for the at least one or more requirement information candidates by concretizing the at least one or more structured requirement information candidates, and wherein the information providing control means provides the generated design information to the user.

### Supplementary Note 4

The information processing apparatus according to supplementary note 3, wherein the concretization control means determines feasibility of each of the at least one or more structured requirement information candidates by attempting to concretize each of the at least one or more structured requirement information candidates, and wherein the information providing control means provides the user with the requirement information candidate that is determined to be feasible and corresponding the design information out of the at least one or more structured requirement information candidates or notify the user of non-existence of feasible design information in the case where the requirement information candidate that is determined to be feasible does not exist.

### Supplementary Note 5

The information processing apparatus according to any one of supplementary notes 1 to 4, further including a knowledge management means that acquires information related to system design as system design information, extracts know-how in the system design from the acquired system design information as knowledge information and structures the extracted knowledge information, and wherein the concretization control means concretize the at least one or more structured requirement information candidates using the structured knowledge information.

### Supplementary Note 6

The information processing apparatus according to supplementary note 5, wherein the concretization control means adds constraint or component acquired from the knowledge information to the at least one or more structured requirement information candidates and concretize the at least one or more structured requirement information candidates to which the constraint or the component has been added.

### Supplementary Note 7

The information processing apparatus according to any one of supplementary notes 2 to 4, wherein the information providing control means provides the user with a result of performing at least one of processing of summarizing, processing of excerpting, and processing of highlighting all or part of the design information.

### Supplementary Note 8

The information processing apparatus according to any one of supplementary notes 2 to 4, wherein the concretization control means calculates a score with respect to each of the at least one or more structured requirement information candidates from a predetermined perspective, and wherein the information providing control means determines information to be provided to the user based on the score of each of the at least one or more structured requirement information candidates.

### Supplementary Note 9

The information processing apparatus according to any one of supplementary notes 2 to 4, wherein the structuring control means generates a plurality of new elements corresponding to the each element by interpreting the each element included in the acquired request information from a different perspective and generates the at least one or more requirement information candidates by combining the generated plurality of new elements.

### Supplementary Note 10

A control method of an information processing apparatus, the control method including: a structuring control step that acquires request information described in a natural language, generates at least one or more requirement information candidates based on the acquired request information, and structures the generated at least one or more requirement information candidates; and a concretization control step that concretizes the at least one or more structured requirement information candidates.

### Supplementary Note 11

The control method of the information processing apparatus according to supplementary note 10, further including an information providing control step that provides information acquired by concretization of the at least one or more structured requirement information candidates to a user.

### Supplementary Note 12

The control method of the information processing apparatus according to supplementary note 11, wherein the concretization control step generates design information for the at least one or more requirement information candidates by concretizing the at least one or more structured requirement information candidates, and wherein the information providing control step provides the generated design information to the user.

### Supplementary Note 13

The control method of the information processing apparatus according to supplementary note 12, wherein the concretization control step determines feasibility of each of the at least one or more structured requirement information candidates by attempting to concretize each of the at least one or more structured requirement information candidates, and wherein the information providing control step provides the user with the requirement information candidate that is determined to be feasible and corresponding the design information out of the at least one or more structured requirement information candidates or notify the user of non-existence of feasible design information in the case where the requirement information candidate that is determined to be feasible does not exist.

### Supplementary Note 14

The control method of the information processing apparatus according to any one of supplementary notes 10 to 13, further including a knowledge management step that acquires information related to system design as system design information, extracts know-how in the system design from the acquired system design information as knowledge information and structures the extracted knowledge information, and wherein the concretization control step concretize the at least one or more structured requirement information candidates using the structured knowledge information.

### Supplementary Note 15

The control method of the information processing apparatus according to supplementary note 14, wherein the concretization control step adds constraint or component acquired from the knowledge information to the at least one or more structured requirement information candidates and concretize the at least one or more structured requirement information candidates to which the constraint or the component has been added.

### Supplementary Note 16

The control method of the information processing apparatus according to any one of supplementary notes 11 to 13, wherein the information providing control step provides the user with a result of performing at least one of processing of summarizing, processing of excerpting, and processing of highlighting all or part of the design information.

### Supplementary Note 17

The control method of the information processing apparatus according to any one of supplementary notes 11 to 13, wherein the concretization control step calculates a score with respect to each of the at least one or more structured requirement information candidates from a predetermined perspective, and wherein the information providing control step determines information to be provided to the user based on the score of each of the at least one or more structured requirement information candidates.

### Supplementary Note 18

The control method of the information processing apparatus according to any one of supplementary notes 11 to 13, wherein the structuring control step generates a plurality of new elements corresponding to the each element by interpreting the each element included in the acquired request information from a different perspective and generates the at least one or more requirement information candidates by combining the generated plurality of new elements.

### Supplementary Note 19

A program causing a computer mounted on an information processing apparatus to perform processing for: a structuring control processing that acquires request information described in a natural language, generates at least one or more requirement information candidates based on the acquired request information, and structures the generated at least one or more requirement information candidates; and a concretization control processing that concretizes the at least one or more structured requirement information candidates.

### Supplementary Note 20

The program according to supplementary note 19, further performing an information providing control processing that provides information acquired by concretization of the at least one or more structured requirement information candidates to a user.

### Supplementary Note 21

The program according to supplementary note 20, wherein the concretization control processing generates design information for the at least one or more requirement information candidates by concretizing the at least one or more structured requirement information candidates, and wherein the information providing control processing provides the generated design information to the user.

### Supplementary Note 22

The program according to supplementary note 21, wherein the concretization control processing determines feasibility of each of the at least one or more structured requirement information candidates by attempting to concretize each of the at least one or more structured requirement information candidates, and wherein the information providing control processing provides the user with the requirement information candidate that is determined to be feasible and corresponding the design information out of the at least one or more structured requirement information candidates or notify the user of non-existence of feasible design information in the case where the requirement information candidate that is determined to be feasible does not exist.

### Supplementary Note 23

The program according to any one of supplementary notes 19 to 22, further performing a knowledge management processing that acquires information related to system design as system design information, extracts know-how in the system design from the acquired system design information as knowledge information and structures the extracted knowledge information, and wherein the concretization control processing concretize the at least one or more structured requirement information candidates using the structured knowledge information.

### Supplementary Note 24

The program according to supplementary note 23, wherein the concretization control processing adds constraint or component acquired from the knowledge information to the at least one or more structured requirement information candidates and concretize the at least one or more structured requirement information candidates to which the constraint or the component has been added.

### Supplementary Note 25

The program according to any one of supplementary notes 20 to 22, wherein the information providing control processing provides the user with a result of performing at least one of processing of summarizing, processing of excerpting, and processing of highlighting all or part of the design information.

### Supplementary Note 26

The program according to any one of supplementary notes 20 to 22, wherein the concretization control processing calculates a score with respect to each of the at least one or more structured requirement information candidates from a predetermined perspective, and wherein the information providing control processing determines information to be provided to the user based on the score of each of the at least one or more structured requirement information candidates.

### Supplementary Note 27

The program according to any one of supplementary notes 20 to 22, wherein the structuring control processing generates a plurality of new elements corresponding to the each element by interpreting the each element included in the acquired request information from a different perspective and generates the at least one or more requirement information candidates by combining the generated plurality of new elements.

Furthermore, all or part of the configurations described in supplementary note 2 to supplementary note 8, which depend on supplementary note 1, may also depend on supplementary note 9 and supplementary note 17 in the same manner as supplementary note 2 to supplementary note 8. Furthermore, not limited to supplementary note 1, supplementary note 9, and supplementary note 17, within the scope that does not deviate from the embodiments described above, all or part of the configurations described as supplementary notes may similarly depend on various hardware, software, various recording means for recording software, or systems.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An information processing apparatus, comprising:
at least one memory storing a set of instructions; and
at least one processor configured to execute the set of instructions to:
acquire request information described in a natural language, generates at least one or more requirement information candidates based on the acquired request information;
structure the generated at least one or more requirement information candidates; and
concretize the at least one or more structured requirement information candidates.

2. The information processing apparatus according to claim 1, wherein the at least one processor is further configured to execute the set of instructions to provide information acquired by concretization of the at least one or more structured requirement information candidates to a user.

3. The information processing apparatus according to claim 2, wherein
the at least one processor is further configured to execute the set of instructions to:
generate design information for the at least one or more requirement information candidates by concretizing the at least one or more structured requirement information candidates; and
provide the generated design information to the user.

4. The information processing apparatus according to claim 3, wherein
the at least one processor is further configured to execute the set of instructions to:
determine feasibility of each of the at least one or more structured requirement information candidates by attempting to concretize each of the at least one or more structured requirement information candidates; and
provide the user with the requirement information candidate that is determined to be feasible and corresponding the design information out of the at least one or more structured requirement information candidates or notify the user of non-existence of feasible design information in the case where the requirement information candidate that is determined to be feasible does not exist.

5. The information processing apparatus according to claim 1, wherein
the at least one processor is further configured to execute the set of instructions to:
acquire information related to system design as system design information;
extract know-how in the system design from the acquired system design information as knowledge information;
structure the extracted knowledge information; and
concretize the at least one or more structured requirement information candidates using the structured knowledge information.

6. The information processing apparatus according to claim 2, wherein
the at least one processor is further configured to execute the set of instructions to:
acquire information related to system design as system design information;
extract know-how in the system design from the acquired system design information as knowledge information;
structure the extracted knowledge information; and
concretize the at least one or more structured requirement information candidates using the structured knowledge information.

7. The information processing apparatus according to claim 3, wherein
the at least one processor is further configured to execute the set of instructions to:
acquire information related to system design as system design information;
extract know-how in the system design from the acquired system design information as knowledge information;
structure the extracted knowledge information; and
concretize the at least one or more structured requirement information candidates using the structured knowledge information.

8. The information processing apparatus according to claim 4, wherein
the at least one processor is further configured to execute the set of instructions to:
acquire information related to system design as system design information;
extract know-how in the system design from the acquired system design information as knowledge information;
structure the extracted knowledge information; and
concretize the at least one or more structured requirement information candidates using the structured knowledge information.

9. The information processing apparatus according to claim 5, wherein
the at least one processor is further configured to execute the set of instructions to:
add constraint or component acquired from the knowledge information to the at least one or more structured requirement information candidates; and
concretize the at least one or more structured requirement information candidates to which the constraint or the component has been added.

10. The information processing apparatus according to claim 2, wherein the at least one processor is further configured to execute the set of instructions to provide the user with a result of performing at least one of processing of summarizing, processing of excerpting, and processing of highlighting all or part of the design information.

11. The information processing apparatus according claim 2, wherein the at least one processor is further configured to execute the set of instructions to:
calculate a score with respect to each of the at least one or more structured requirement information candidates from a predetermined perspective; and
determine information to be provided to the user based on the score of each of the at least one or more structured requirement information candidates.

12. The information processing apparatus according to claim 2, wherein
the at least one processor is further configured to execute the set of instructions to:
generate a plurality of new elements corresponding to the each element by interpreting the each element included in the acquired request information from a different perspective; and
generate the at least one or more requirement information candidates by combining the generated plurality of new elements.

13. A control method of an information processing apparatus, the control method comprising:
acquiring request information described in a natural language, generates at least one or more requirement information candidates based on the acquired request information;
structuring the generated at least one or more requirement information candidates; and
concretizing the at least one or more structured requirement information candidates.

14. A non-transitory computer-readable storage medium storing a program causing a computer mounted on an information processing apparatus to perform processing for:
acquiring request information described in a natural language, generates at least one or more requirement information candidates based on the acquired request information;
structuring the generated at least one or more requirement information candidates; and
concretizing the at least one or more structured requirement information candidates.
